(19) United States
(12) Patent Application Publication
(10) Pub. No.: US 2017/0096052 A1
(43) Pub. Date: Apr. 6, 2017

(54) ROTATING SHAFT MOVEMENT STRUCTURE FOR DOOR CURTAIN

(71) Applicant: Hyundai Motor Company, Seoul (KR)

(72) Inventor: Dong-Keun Yoo, Ansan (KR)

(21) Appl. No.: 15/133,401

(22) Filed: Apr. 20, 2016

(30) Foreign Application Priority Data
Oct. 5, 2015 (KR) 10-2015-0139735

(51) Int. Cl. B60J 1/20

(52) U.S. Cl. CPC B60J 1/2061; B60J 1/2066

(57) ABSTRACT

A rotating shaft movement structure for a door curtain is provided. The rotating shaft movement structure includes a shaft that is mounted to a door trim panel at a position adjacent to a window glass of a vehicle and the door curtain is wound around the shaft. A stationary cover is disposed at an end of the shaft and includes a slit into which the end of the shaft is inserted. The shaft is vertically movable as the end of the shaft slides in the slit, whereby variation in assembly between the left and right sides of the door curtain may be compensated.

### CROSS-REFERENCE TO RELATED APPLICATION

This application claims the priority benefit of Korean Patent Application No. 10-2015-0139735, filed on Oct. 5, 2015 in the Korean Intellectual Property Office, the disclosure of which is incorporated herein by reference.

### BACKGROUND

1. Field of the Invention

The present invention relates to a door curtain of a vehicle, and more particularly, to a rotating shaft movement structure for a door curtain, in which a shaft, around which the door curtain is wound, is moved vertically along a slit in a stationary cover, whereby sagging and wrinkling of the door curtain, caused by variation in assembly between the left and right sides of the door curtain, is prevented.

2. Description of the Related Art

Generally, a window glass of a vehicle is installed to secure visibility a passenger compartment of the vehicle. However, in the summer or warmer weather months, a substantial amount of direct light passes through the window glass, increasing the temperature inside the vehicle and generating glare. In addition, when the passenger compartment of the vehicle needs to be protected from the exterior, the window glass may be inconvenient in that it allows invasion of privacy.

Therefore, a door curtain may be installed at a side door or a rear door of the vehicle to shield the window glass, to ensure privacy and block sunlight. Such a door curtain is categorized into an automated door curtain, which is driven by a motor via the operation of a button, and a manual door curtain, which is manually lifted and latched onto on a hook mounted on the upper frame of the door.

FIG. 1 is a view illustrating a door provided with a conventional door curtain according to the related art. As illustrated in FIG. 1, the conventional door curtain includes a door curtain 1, which is wound around a shaft 3 and is mounted to be vertically moved from a door trim panel 3′ at a position adjacent to the window glass, and a shade bar 2, which is coupled to the upper end of the door curtain 1 to allow the door curtain 1 to be caught by hooks 4 disposed at the top of the door.

However, the above-described configuration of the conventional door curtain entails accumulative variation in assembly due to various components such as, for example, a door belt line, a door panel, a door frame, and a frame cover, assembled between the upper end of the door trim panel 3′, to which the door curtain 1 is fixed, and the hooks 4, by which the door curtain 1 is latched, which problematically causes a difference between the tension applied to respective opposite sides of the door curtain 1.

In other words, the door curtain may sag or be wrinkled due to the difference between the tension applied to opposite sides of the door curtain 1, which is aesthetically displeasing to consumers and causes the door curtain 1 to flap in a slight wind, generating rattling noise. In addition, when tension is applied to only one side of the door curtain and insufficient tension is applied to the other side may occur, thus causing a considerable deterioration in the installation stability of the door curtain, and also causing the shade bar to become separated from the hook due to shaking during driving.

The matters described as the related art have been provided merely for facilitating the understanding of the background of the present invention and should not be construed as acknowledging them as the related art already known by those skilled in the art.

### SUMMARY

Therefore, the present invention provides a rotating shaft movement structure for a door curtain, in which a shaft, around which the door curtain is wound, may be moved vertically to compensate for variation in the assembly of the door curtain.

In addition, the present invention to provides a rotating shaft movement structure for a door curtain, which may compensate for variation in the assembly of the door curtain, thereby eliminating the difference between the tension applied to respective opposite sides of a shade bar and preventing sagging and wrinkling of the installed door curtain.

Technical objects to be achieved by the present invention are not limited to those mentioned above, and other objects may be clearly understood by those skilled in the art from the description given below.

In accordance with the present invention, a rotating shaft movement structure for a door curtain may include a shaft mounted to a door trim panel at a position adjacent to a window glass of a vehicle, the door curtain being wound around the shaft, and a stationary cover disposed at one end (e.g., a first end) of the shaft, the stationary cover having a slit into which the end of the shaft may be inserted, wherein the shaft may be vertically movable as the end of the shaft slides into the slit.

In addition, the rotating shaft movement structure for the door curtain in accordance with the exemplary embodiment of the present invention may further include a movement restriction bracket coupled to the stationary cover at a position above the slit, the movement restriction bracket configured to apply pressure to the end of the shaft. Further, the end of the shaft may have a width equal to or less than a width of the slit and may also have a vertical length greater than the width of the slit, and thus, the end of the shaft may move vertically without rotation.

The movement restriction bracket may include a mounting portion having a first end inserted into a side surface of the stationary cover and a second end supported by a top of the slit, and a pressure portion configured to extend downward from the mounting portion, the pressure portion having a tip end configured to apply pressure to and support the end of the shaft. Additionally, the movement restriction bracket may have the form of a leaf spring.

### BRIEF DESCRIPTION OF THE DRAWINGS

The above and other objects, features and other advantages of the present invention will be more clearly understood from the following detailed description taken in conjunction with the accompanying drawings, in which:

FIG. 1 is a view illustrating a door provided with a conventional door curtain according to the related art;

FIG. 2 is a view illustrating a rotating shaft movement structure for a door curtain in accordance with an exemplary embodiment of the present invention;

FIG. 3 is an enlarged view illustrating portion A of FIG. 2 in accordance with an exemplary embodiment of the present invention;

FIG. 4 is a sectional view taken along line B-B′ of FIG. 3 in accordance with an exemplary embodiment of the present invention; and

FIGS. 5A-5C are views illustrating the operating state of a shaft end in accordance with an exemplary embodiment of the present invention.

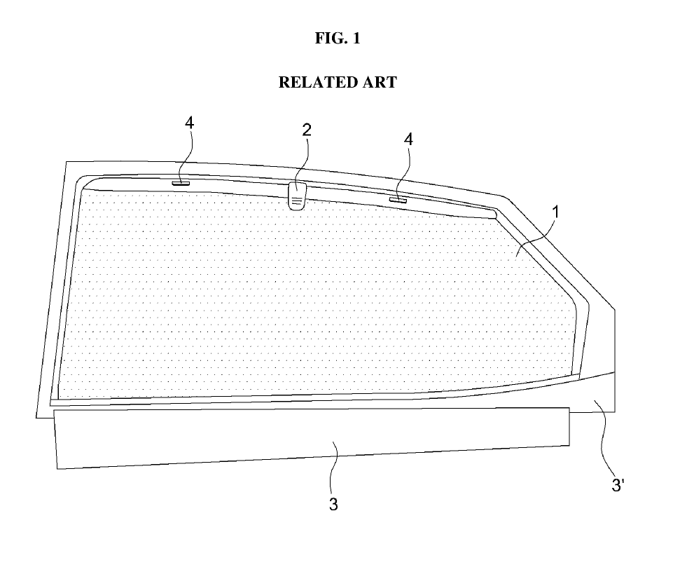

### DETAILED DESCRIPTION

It is understood that the term “vehicle” or “vehicular” or other similar term as used herein is inclusive of motor vehicles in general such as passenger automobiles including sports utility vehicles (SUV), buses, trucks, various commercial vehicles, watercraft including a variety of boats and ships, aircraft, and the like, and includes hybrid vehicles, electric vehicles, combustion, plug-in hybrid electric vehicles, hydrogen-powered vehicles and other alternative fuel vehicles (e.g. fuels derived from resources other than petroleum).

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. As used herein, the term “and/or” includes any and all combinations of one or more of the associated listed items.

Unless specifically stated or obvious from context, as used herein, the term “about” is understood as within a range of normal tolerance in the art, for example within 2 standard deviations of the mean. “About” can be understood as within 10%, 9%, 8%, 7%, 6%, 5%, 4%, 3%, 2%, 1%, 0.5%, 0.1%, 0.05%, or 0.01% of the stated value. Unless otherwise clear from the context, all numerical values provided herein are modified by the term “about.”

Hereinafter, the present invention will be described in detail with reference to the accompanying drawings to allow those skilled in the art to easily practice the present invention. However, the present invention may be embodied in many different forms and is not limited to exemplary embodiments described herein. In the drawings, to clearly describe the present invention, parts extrinsic to the description are not illustrated, and the same or similar elements are denoted by the same reference numerals even though they are depicted in different drawings.

In addition, the terms or words used in the specification and claims of the present invention are not interpreted using typical or dictionary limited meanings, and are constructed as meanings and concepts conforming to the technical sprit of the present invention based on the principle that the inventors can appropriately define the concepts of the terms to explain the present invention in the best manner

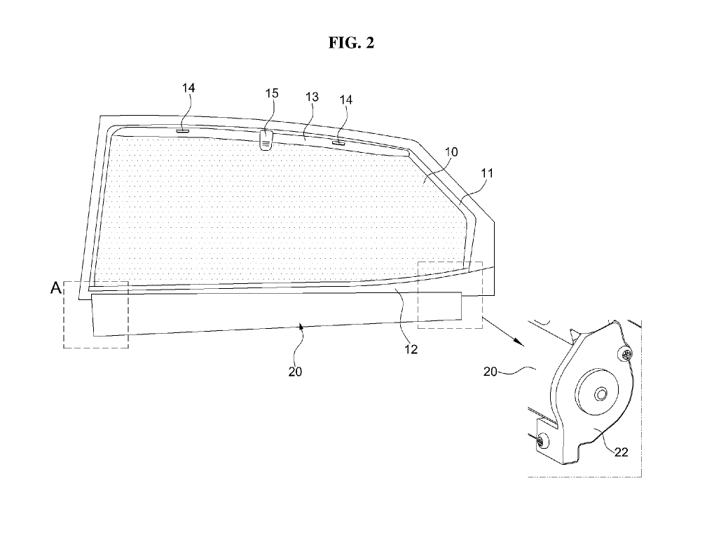

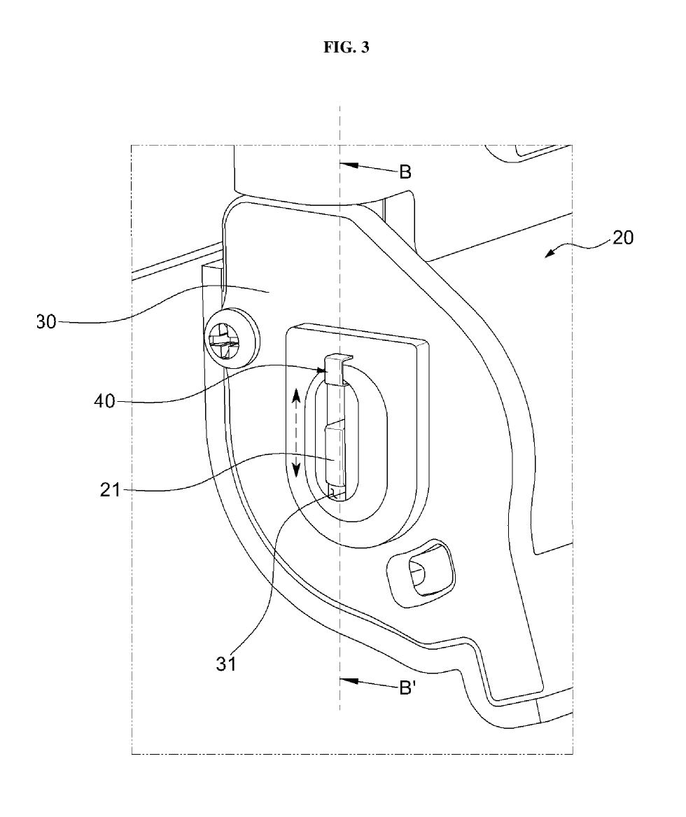

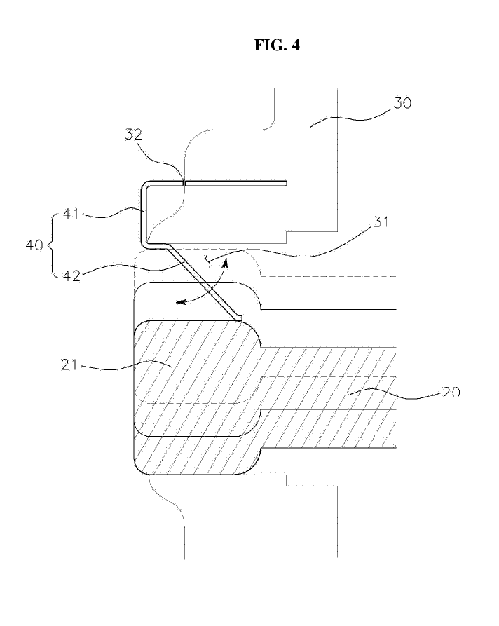

FIG. 2 is a view illustrating a rotating shaft movement structure for a door curtain in accordance with an exemplary embodiment of the present invention in brief, FIG. 3 is an enlarged view illustrating portion A of FIG. 2, and FIG. 4 is a sectional view taken along line B-B′ of FIG. 3.

As illustrated in FIG. 2, the rotating shaft movement structure for the door curtain according to the present invention, likewise the related art, may include a shaft 20, around which the door curtain 10 is wound, the shaft 20 being mounted to a door trim panel 12 to be adjacent to the window glass 11 of a vehicle, and a shade bar 13, coupled to the upper end of the door curtain 10 to allow the door curtain 10 to be caught by hooks 14 (e.g., latched onto the hooks 14) arranged at the top of a door. In other words, the door curtain 10 used in the present invention is a manual type. Thus, the door curtain 10 may be lifted by gripping a handle 15 coupled to the upper end of the door curtain 10, and thereafter the door curtain 10 may be secured by inserting the hooks 14 into apertures formed in the shade bar 13.

For the previously described configuration of the conventional door curtain, variation in assembly may be increased due to various components such as, for example, a door belt line, a door panel, a door frame, and a frame cover, assembled between the upper end of the door trim panel, to which the door curtain is fixed, and the hooks, by which the door curtain is latched, and consequently, a difference between the tension applied to respective opposite sides of the door curtain may occur.

To solve the problem described above, as illustrated in FIG. 3, in the present invention, a stationary cover 30 may be disposed at one end 21 (e.g., a first end) of the shaft 20. The stationary cover 30 may include a slit 31 formed therein and into which the shaft end 21 may be inserted to enable the vertical movement of the shaft 20. As illustrated in FIG. 3, since the slit 31 formed in the stationary cover 30, is vertically elongated, the shaft end 21 may be inserted into the slit 31 to vertically slide along the slit 31. The vertical sliding of the shaft end 21 may thus adjust the tension applied to respective opposite sides of the door curtain 10 and allow the tension to be equal between the sides of the door curtain 10.

Further, as illustrated in FIG. 2, a rotational cover 22 may be disposed at the other end (e.g., a second end) of the shaft 20 and the other end of the shaft 20 may be rotatably coupled to the rotational cover 22. Accordingly, the second end of the shaft 20 may rotate in place, rather than being vertically moved. This configuration causes the vertical movement of the shaft 20 to occur at the side of the stationary cover 30 that causes relatively low friction since friction occurs at the side of the rotational cover 22, at which rotation of the shaft 20 occurs, while the door curtain 10 is vertically moved.

Meanwhile, the width of the shaft end 21 may be equal to or less than the width of the slit 31 and the vertical length of the shaft end 21 may be greater than the width of the slit 31, and thus, the shaft end 21 may perform vertical movement without rotation. In other words, the shaft end 21 may have a vertically elongated rectangular cross-sectional shape and the slit 31 may also have a vertically elongated rectangular cross-sectional shape, whereby the shaft end 21 may be movable in the vertical direction. Accordingly, based on such a structure, the rotational cover 22 may be limited to be rotated and the stationary cover 30 may be limited to be moved in the vertical direction with the rotation thereof being limited to within the maximum extent, since the shaft 20 tends to continuously rotate as described above.

In addition, as illustrated in FIGS. 3 and 4, a movement restriction bracket 40 may be coupled to the side portion of the stationary cover 30 above the slit 31, and may be configured to apply pressure to the shaft end 21. Specifically, the movement restriction bracket 40 may include a mounting portion 41, one end (e.g., a first end) of which may be inserted into the side surface of the stationary cover 30 and the other end (e.g., a second end) of which may be supported by the top of the slit 31, and a pressure portion 42, which extends downward from the mounting portion 41 to cause the tip end thereof to apply pressure to and support the shaft end 21.

In the illustrated exemplary embodiment, the mounting portion 41 may have a “U”-shaped cross-section, one end of which may be inserted into a mounting aperture 32 formed in the side surface of the stationary cover 30 and the other end of which comes into contact with (e.g., abuts) and is supported by the top of the slit 31. The pressure portion 42 may extend downward from a second end of the mounting portion 41 by a predetermined inclination, and may be pivotable about the second end of the mounting portion 41. The movement restriction bracket 40, which may include the mounting portion 41 and the pressure portion 42, may have the form of a leaf spring.

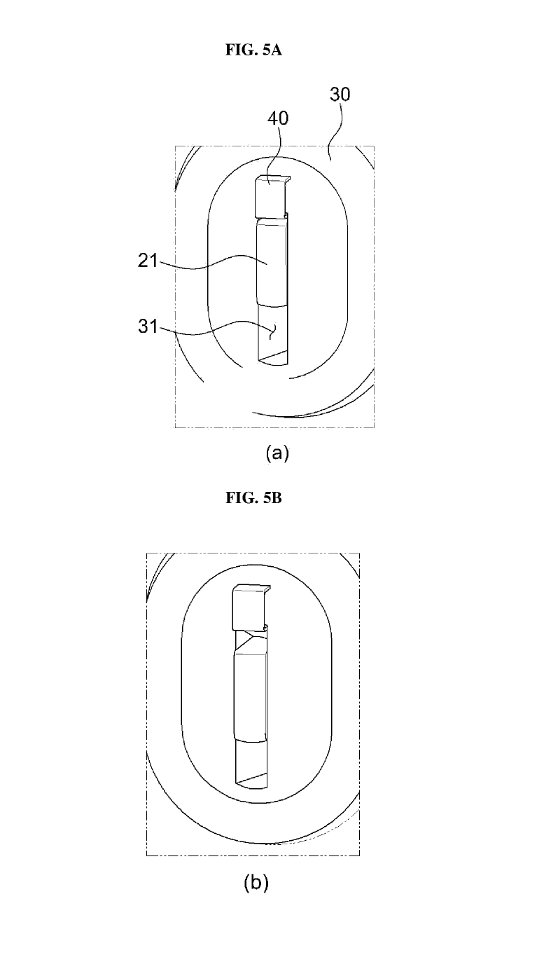

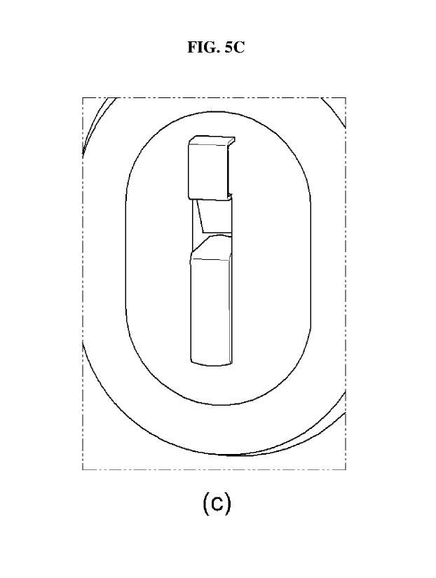

FIGS. 5A-5C are views illustrating the operating state of the shaft end in accordance with an exemplary embodiment of the present invention. As illustrated in FIG. 5B, in a normal state (e.g., an unpulled state, resting state, or original position), the shaft end 21 may be disposed at the approximate middle of the slit 31 since the pressure applied by the movement restriction bracket 40 may be balanced with the pulling force of the door curtain 10.

As illustrated in FIG. 5A, when the distance between the door trim panel 12 and the hooks 14 is less than the normal state, causing excessive tension to be applied to the door curtain 10, the shaft end 21 may overcome the elasticity of the movement restriction bracket 40 and thus may be moved upward to be located at the upper end of the slit 31. Particularly, the movement distance (e.g., displacement) may be about 1.5 mm.

As illustrated in FIG. 5C, when the distance between the door trim panel 12 and the hooks 14 is greater than the normal state, in which minimal tension is applied to the door curtain 10, the shaft end 21 may be moved downward by the elasticity of the movement restriction bracket 40 to be located at the lower end of the slit 31. The movement distance (e.g., displacement) may be about 1.5 mm. In other words, the shaft end 21 may be vertically movable within a distance of about 3 mm, and the distance may be determined based on variation in the assembly of the door curtain 10.

With the rotating shaft movement structure for the door curtain having the above-described configuration in accordance with the exemplary embodiment of the present invention, it may be possible to eliminate the difference between the tension applied to respective opposite sides of the shade bar, which has the effect of preventing sagging and wrinkling of the installed door curtain.

As is apparent from the above description, in the present invention, a shaft operating as a rotating shaft of a door curtain may be vertically movable along a slit formed in a stationary cover coupled to a first end of the shaft. The vertical movement of the shaft may compensate for variation in assembly between the left and right sides of the door curtain, which has the effect of balancing the tension applied to the opposite sides of the door curtain.

Accordingly, the present invention has the effect of preventing sagging or wrinkling of the door curtain, thereby providing a consumer with visual satisfaction and preventing rattling noise generated when the door curtain flaps. In addition, in the present invention, a shaft end, which may be slidably inserted into the slit, may be limited to move vertically and rotation may be prevented, which has the effect of preventing continuous friction caused by rotation of the shaft. In addition, the present invention has an advantage in that a height adjustment process, which is conducted after the door curtain is mounted, may be eliminated since the vertical height of the shaft may be automatically adjusted using a movement restriction bracket.

Although the exemplary embodiments of the present invention have been disclosed for illustrative purposes, those skilled in the art will appreciate that various modifications, additions and substitutions are possible, without departing from the scope and spirit of the invention as disclosed in the accompanying claims.

What is claimed is:

1. A rotating shaft movement structure for a door curtain, comprising:
a shaft mounted to a door trim panel at a position adjacent to a window glass of a vehicle, the door curtain being wound around the shaft; and
a stationary cover disposed at a first end of the shaft, the stationary cover having a slit into which the first end of the shaft is inserted,
wherein the shaft is vertically movable as the first end of the shaft slides in the slit.

2. The structure according to claim 1, further comprising:
a movement restriction bracket coupled to the stationary cover at a position above the slit, the movement restriction bracket configured to apply pressure to the first end of the shaft.

3. The structure according to claim 1, wherein the first end of the shaft has a width equal to or less than a width of the slit and a vertical length greater than the width of the slit, to limit the first end of the shaft to vertical movement without rotation.

4. The structure according to claim 2, wherein the movement restriction bracket includes:
a mounting portion having a first end inserted into a side surface of the stationary cover and a second end supported by a top of the slit; and
a pressure portion configured to extend downward from the mounting portion, the pressure portion having a tip end configured to apply pressure to and support the first end of the shaft.

5. The structure according to claim 2, wherein the movement restriction bracket has the form of a leaf spring.

6. The structure of claim 1, further comprising:
a rotational cover disposed at a second end of the shaft to allow the second end of the shaft to rotate.
